(19) United States
(12) Patent Application Publication
(10) Pub. No.: US 2004/0233979 A1
(43) Pub. Date: Nov. 25, 2004

(54) Long range broadband modem

(75) Inventors: Abraham Fisher, Haifa (IL); Amnon Gavish, D.N. Bikat Beit Hakerem (IL); Assaf Kasher, Haifa (IL)

Correspondence Address: William H. Dippert, Esq., c/o Reed Smith LLP, 29th Floor, 599 Lexington Avenue, New York, NY, 10022-7650, US

(73) Assignee: Surf Communication, Yokneam (IL)

(21) Appl. No.: 10/849,653

(22) Filed: May 20, 2004

(30) Foreign Application Priority Data
May 20, 2003 (IL) 156018

(51) Int. Cl. H04B 1/38

(52) U.S. Cl. 375/222

(57) ABSTRACT

A method of establishing a modem connection. The method includes determining properties of a line carrying the modem connection and selecting a plurality of frequency sub-bands to pass on the connection responsive to the determination of the properties, the selection including determining the bandwidth of at least one of the sub-bands.

### FIELD OF THE INVENTION

The present invention relates generally to modem communications and particularly to broadband modems.

### BACKGROUND OF THE INVENTION

The available twin pair copper lines connecting houses to the telephone network are commonly used to provide data communication services, such as Internet access. One method of providing data communication services over the copper lines includes utilizing the voice frequency band, such as using voice band modem (VBM) modulation methods, for example according to the V.34 standard. Using the voice frequency band is very cheap as it does not require adding additional hardware to the network. The use of only the voice band frequencies, however, is limited in its bandwidth, which generally reaches a maximum of 56 kbps.

Another method of providing data communication services includes installing a dedicated server DSL modem at the telephone switch box servicing the user. There exist many different types of DSL modems which differ in the modulation method they use, the bandwidth they use, the distance they support and in other attributes. The DSL modems may be divided into two general types, DSL modems that override the regular telephone service passing on the line and DSL modems that use higher frequency bands so as not to disturb the regular telephone service.

When DSL modems that override the regular telephone service are used, telephone service may be provided by converting the analog voice signals into digital data signals and transmitting the voice digital data signals together with the data on the line. This requires special telephone units that can covert the voice signals into digital form. DSL modems that override the regular telephone service include ISDN and HDSL. The HDSL modems are generally used by businesses and not by home users.

DSL modems that use higher frequency bands include, for example, ADSL (asymmetric digital subscriber line), VDSL (very high bit rate digital subscriber line) and SDSL (symmetric digital subscriber line) modems. In a first category of ADSL, separate frequency bands are used for upstream and downstream transmission. In this category, ADSL uses the frequency band between 28-138 kHz for upstream transmissions and between 200-1104 KHz for downstream transmission. In a second category, ADSL utilizes the band between 28-138 for both upstream and downstream transmission, while the band between 138-1104 kHz is used only for downstream transmission. The bandwidth utilized by ADSL is divided into predetermined frequency strips of 4 kHz, which each uses a separate carrier. During a training session of the connection, each of the frequency strips is tested and the modems determine which strips are to be used and what data rate to transmit on each strip. The ADSL modems do not use frequencies beneath about 28 kHz, in order not to interfere, and not to be interfered by, the telephone service passing on the voice band of the line.

In order to improve the signal reception in ADSL, U.S. Pat. No. 6,226,322 to Mukherjee, the disclosure of which is incorporated herein by reference, suggests employing an impedance matching circuit at the receiver.

Another DSL modem, referred to as a multi-rate DSL modem, is described in U.S. Pat. No. 6,002,722, to Wu, the disclosure of which is incorporated herein by reference.

The quality of transmission over twin pair copper lines deteriorates with the length of the copper line, particularly the attenuation of transmitted signals increases with the length of the copper line. The attenuation increases more rapidly for higher frequencies. Thus, although copper lines of distances of above 10 and even 15 kilometers provide satisfactory voice band transmission, they are not suitable for DSL transmission. Generally, each DSL modem type has a distance limit, generally between 1-7 kilometers, beyond which it cannot operate.

U.S. Pat. No. 6,539,081, to Zakrzewski, et al., the disclosure of which is incorporated herein by reference, describes an autobaud mechanism which is executed on a communication loop to provide extended range ADSL service.

### SUMMARY OF THE INVENTION

An aspect of some embodiments of the invention relates to utilizing a twin pair copper line for both regular telephone service and for a broadband data service that uses a frequency band including frequencies close to the voice frequency band, i.e., beneath 10 kHz. Optionally, the separation gap between the voice band and the data service band is less than about 2-3 kHz.

A broad aspect of some embodiments of the invention relates to a broadband modem connection for twin pair copper lines, which carries data signals on a plurality of separate sub-bands.

In some embodiments of the invention, the widths of the sub-bands are adjusted dynamically according to a probing of the line quality. Dynamically adjusting the width of the sub-bands allows maximization of the utilization of the bandwidth without requiring too much processing resources. Optionally, frequency gaps are left between the sub-bands. In some embodiments of the invention, the widths of the gaps are determined dynamically according to the line conditions and/or user preferences.

Alternatively or additionally, different ones of the sub-bands in a same direction (e.g., downstream) have different widths. Optionally, the different sub-bands in the same direction are adjacent each other, i.e., are not separated by a sub-band in an opposite direction. Allowing for sub-bands of different widths allows for better utilization of the bandwidth. When possible, relatively large width sub-bands are optionally used, in order to reduce the processing power required from the modems, and to reduce the waste of bandwidth on gaps between the sub-bands. The use of such gaps allows proper filtering of the signals of the sub-band, thus substantially eliminating effects from other frequencies on the signals of the sub-band. Conversely, when necessary, relatively narrow bands are used where the conditions of the line change substantially over short frequency ranges, so that the utilization of the frequency band may be maximized.

In some embodiments of the invention, a plurality of adjacent sub-bands in the same direction are each handled separately. Optionally, the number of sub-bands is not regular, i.e., is not divisible by 64. For example, 3-7 sub-bands may be used, when advantageous.

An aspect of some embodiments of the invention relates to a broadband modem connection for twin pair copper lines in which the frequency bands used for upstream and downstream transmission are selected dynamically, e.g., each time the connection is trained. Optionally, separate frequency bands are used for upstream and downstream transmission and the selection of the frequency bands includes selecting the size of each of the upstream and downstream bands and/or a frequency gap between the upstream and downstream bands.

In some embodiments of the invention, the frequency bands are divided into sub-bands with separate carriers. Optionally, the transmission rate on the separate sub-bands is determined separately for each sub-band. Alternatively or additionally, each sub-band operates with a separate timer. Optionally, the division into the sub-bands is determined dynamically. The division optionally includes the widths of the sub-bands and/or the gaps between the sub-bands.

Alternatively or additionally, a predetermined number of frequency bands are permanently assigned for either upstream or downstream, while one or more other carriers are assigned dynamically to either upstream or downstream use according to the needs of the application layer and/or according to the line conditions.

In some embodiments of the invention, the lower frequencies are used for upstream transmission, as these frequencies are less susceptible to crosstalk from other lines, and the CO modem, which receives the upstream signals, has more lines from which to receive crosstalk.

In some embodiments of the invention, the selection of the frequency bands is performed based on the line conditions so as to achieve a desired upstream and/or downstream data rate. Optionally, the desired data rates are pre-configured at the time of installation of the modems of the connection. Alternatively or additionally, the desired data rates may be set by an application layer before any training or retraining. In some embodiments of the invention, the desired upstream and/or downstream data rates are defined in terms of a ratio according to which the available bandwidth is to be divided. Alternatively or additionally, a desired minimal upstream and/or downstream data rate is defined for the connection. Optionally, the application layer settings are partially or entirely controlled by a human user indicating the desired division of the bandwidth.

An aspect of some embodiments of the invention relates to a modem connection between modems having impedance matching circuits, in which the values of the impedance matching circuit are adjusted in cooperation between both modems of the connection.

In some embodiments of the invention, the adjustment is performed once at the time of installation of the modems at a specific copper wire. Alternatively or additionally, the adjustment is performed periodically, for example each time the modems connect, in order to better confirm to changing conditions of the wire, e.g., due to temperature.

An aspect of some embodiments of the invention relates to a modem which passes the signals it transmits through an impedance matching circuit. Optionally, the impedance matching circuit is adjustable.

Optionally, the adjustment of the impedance matching circuit is performed iteratively, each of the modems performing in turn a small change which improves the reception quality of the modem and/or reduces echo effects. Optionally, between iterations the opposite-end modem checks the effect of the change on its reception of signals and notifies the other modem if the change is to be cancelled due to an adverse effect on the opposite-end modem.

An aspect of some embodiments of the invention relates to a multi-carrier modem connection on which a retrain may be performed on one or more sub-bands, while other sub-bands continue to carry data. Optionally, each of the sub-bands has a separate timer not related to the other sub-bands.

An aspect of some embodiments of the invention relates to a modem connection establishment method in which line conditions are probed for a plurality of different bandwidth allocation schemes. During data transfer, a fast retraining may be performed to switch between different bandwidth allocation schemes, based on the previously determined probing results. Thus, the modem connection may be adjusted to varying bandwidth needs and/or to varying line conditions, without performing a complete connection establishment procedure.

An aspect of some embodiments of the invention relates to a modem connection establishment method in which an application layer may control one or more parameters of the bandwidth allocation of the connection, for example the number of carriers into which the bandwidth is divided and/or the bandwidth distribution between the upstream and the downstream.

An aspect of some embodiments of the invention relates to a modem connection establishment procedure which allows a human user to determine whether the modem connection is to use the voice band.

There is therefore provided in accordance with an exemplary embodiment of the invention, a method of establishing a modem connection, comprising determining properties of a line carrying the modem connection and selecting a plurality of frequency sub-bands to pass on the connection responsive to the determination of the properties, the selection including determining the bandwidth of at least one of the sub-bands.

Optionally, the determined properties include an echo of the line. Optionally, the determined properties include an attenuation of the line. Optionally, selecting the plurality of frequency sub-bands comprises selecting a plurality of sub-bands in a same direction.

Optionally, at least two adjacent sub-bands in the same direction have different bandwidths. Optionally, selecting the plurality of frequency sub-bands comprises selecting at least one uplink sub-band and at least one downlink sub-band. Optionally, in at least one gap of bandwidth not used by the modem connection is left between at least two of the plurality of sub-bands. Optionally, the selecting includes selecting the width of the at least one gap.

There is further provided in accordance with an exemplary embodiment of the invention, a method of establishing a modem connection, comprising determining properties of a line carrying the modem connection, selecting a plurality of frequency sub-bands to pass on the connection responsive to the determination of the properties, the plurality of sub-bands including at least two sub-bands carrying data in the same direction, which have different band widths and training the selected sub-bands for data transmission.

Optionally, training the selected sub-bands is performed with separate, unrelated, timers.

There is therefore provided in accordance with an exemplary embodiment of the invention, a method of preparing a modem connection for data transmission, comprising determining properties of a line carrying the modem connection and selecting frequencies to be used for upstream transmission and frequencies to be used for downstream transmission, responsive to the determination of the properties, the frequency selection including determining for at least one frequency whether it is to be included in an upstream or downstream frequency band.

Optionally, selecting the frequencies for upstream and downstream transmission comprises selecting additionally responsive to an application layer indication of selection preference. Optionally, the method includes dividing the selected upstream or downstream frequencies into a plurality of sub-bands with separate carriers.

There is therefore provided in accordance with an exemplary embodiment of the invention, a method of preparing a modem for data transmission on a communication line, comprising transmitting test signals on the communication line, receiving an indication on reception properties of the test signals or on required impedance matching changes from an opposite end modem connected to the line and adjusting an impedance matching circuit of the modem responsive to the received indication.

### BRIEF DESCRIPTION OF THE FIGURE

Exemplary non-limiting embodiments of the invention will be described with reference to the following description of the embodiments, in conjunction with the figures. Identical structures, elements or parts which appear in more than one figure are preferably labeled with a same or similar number in all the figures in which they appear, and in which:

FIG. 1 is a schematic illustration of a modem connection, in accordance with an exemplary embodiment of the invention;

FIG. 2 is a block diagram of client modem, in accordance with an exemplary embodiment of the invention;

FIGS. 3A and 3B are schematic block diagrams of a modulator/demodulator, in accordance with two alternative exemplary embodiment of the invention;

FIG. 4 is a flowchart of acts performed in managing a wide-band modem connection, in accordance with an exemplary embodiment of the invention;

FIG. 5 is a flowchart of acts performed in adjusting impedance matching circuits of modems of a modem connection, in accordance with an exemplary embodiment of the invention; and

FIG. 6 is a flowchart of acts performed in choosing upstream and downstream bands of a modem connection, in accordance with an exemplary embodiment of the invention.

### DETAILED DESCRIPTION OF EMBODIMENTS

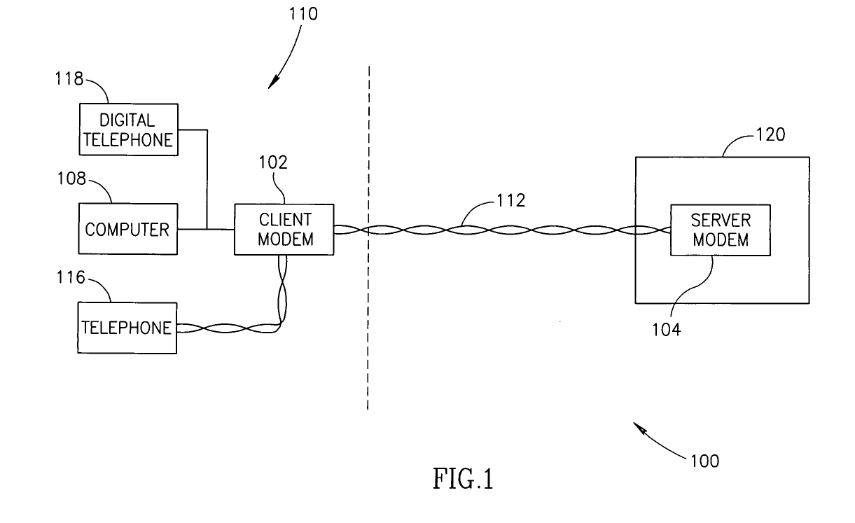

FIG. 1 is a schematic illustration of a modem connection 100, in accordance with an exemplary embodiment of the invention. A client location 110 is connected through a twin pair (TP) copper wire 112 to a central office (CO) 120 of a telephone provider. In order to provide client location 110 with broadband data services, a client modem 102 is installed in client location 110, for example servicing a computer 108. A server modem 104 compatible to client modem 102 is installed in CO 120, on its own or as part of an array of broadband modems for servicing a plurality of clients. Although directed primarily for use with TP copper wires of telephone services, some aspects of the present invention may be implemented on other types of lines, such as coaxial or shielded lines.

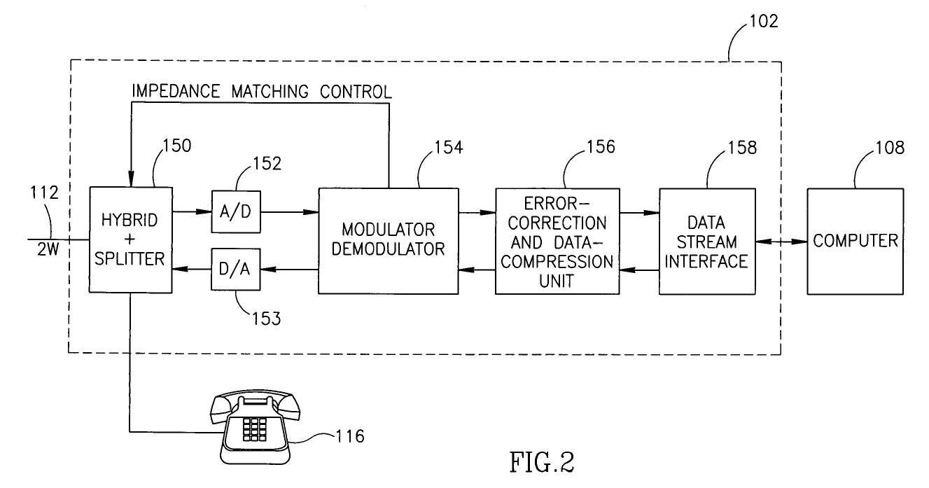

In some embodiments of the invention, client modem 102 includes a splitter (FIG. 2) which allows connection of a telephone 116 to TP wire 112, in parallel to client modem 102. Alternatively or additionally, client location 110 includes a digital telephone 118 which allows transmission of telephone sessions through a broadband data connection between client modem 102 and server modem 104. Further alternatively or additionally, client location 110 does not receive telephone service over copper wire 112 at all or while the data connection is operative.

In accordance with some embodiments of the invention, copper wire 112 is long (e.g., longer than 5 kilometers, or even 10 kilometers) such that client location 110 cannot normally receive broadband service using broadband modem connections known in the art (e.g., ISDN, ADSL, VDSL).

FIG. 2 is a block diagram of client modem 102, in accordance with an exemplary embodiment of the invention. Client modem 102 optionally includes a hybrid circuit 150, which connects modem 102 to TP wire 112 and optionally matches the modem to wire 112. An analog to digital (A/D) converter 152 and a digital to analog (D/A) converter 153 optionally converts analog signals from hybrid circuit 150 into digital samples and digital samples for transmission onto wire 112 into analog signals. A modulator/demodulator 154 modulates data transmitted onto wire 112 and demodulates data received from wire 112. In some embodiments of the invention, an error correction (EC) and data compression (DC) unit 156 corrects errors in data received from the line and compresses and decompresses the transmitted signals, for example as is known in the art for voice band modems (VBM), such as V.34 modems. A data stream interface 158 optionally interfaces between computer 108 and client modem 102.

Modulator/demodulator 154 and ECDC unit 156 are optionally implemented in software on a single processor, for example on a digital signal processor (DSP), such as the C6211 DSP. Alternatively, modulator/demodulator 154 and ECDC unit 156 may be implemented on separate processors and/or may be implemented partially or entirely in dedicated hardware. In addition, the functions of modem 102 may be distributed differently between the blocks forming the modem.

As discussed above, in some embodiments of the invention, hybrid 150 includes a splitter which passes voice band signals between telephone 116 (or other POTS serviced unit) and TP wire 112. The splitter optionally includes a relatively steep filter for isolating voice band signals and passing them to telephone 116. The steep filter is used such that the size of the gap between the voice band and the frequencies used for broadband transmission of data is minimal. In some embodiments of the invention, the slope of the filter is not too steep, for example ranging over the 4-8 kHz band, such that filter does not substantially distort signals in frequencies beyond the end of the slope. Alternatively, a steeper slope is used (e.g., ranging over the 4-6 kHz band), so that the gap of unused frequencies is smaller. Optionally, in this second alternative, the transmission rate in data frequencies adjacent the filter use relatively slow bit rates, so that distortions from the filter do not prevent data transmission.

Hybrid 150 optionally includes an internal impedance matching circuit which matches the impedance of copper wire 112. The impedance matching circuit optionally includes resistors, inductors and/or a combination thereof. Alternatively or additionally, capacitors may be used in implementing the impedance matching circuit. In some embodiments of the invention, the internal impedance matching circuit of hybrid 150 includes elements (e.g., resistors, inductors, capacitors) that have a controllable impedance, such that the impedance of the hybrid can be controlled to accurately match the current conditions of copper wire 112, over the relevant band of frequencies.

Alternatively or additionally, an impedance matching circuit is positioned between hybrid 150 and A/D 152, for example as described in the above mentioned U.S. Pat. No. 6,226,322. Having the impedance circuit in hybrid 150, however, allows the transmitted signals to pass through the hybrid and hence enjoy the improved performance due to the impedance matching.

A/D converter 152 and D/A converter 153 optionally operate with high precision words, having for example between 16-20 bits. The sampling optionally operates at a sufficiently high rate so that substantially all the useful frequency bandwidth of copper wire 112 may be properly handled by modulator/demodulator 154. In an exemplary embodiment of the invention, modems 102 and 104 are planned for use with TP wires 112 having a length of above 10 kilometers. Therefore, A/D converter 152 optionally does not operate at a very high rate which is required for very high frequencies, which cannot be handled by such long copper wires 112. In an exemplary embodiment of the invention, A/D converter 152 operates at a sampling rate of between about 100,000-200,000 samples a second, suitable for frequencies of up to 50-100 kHz.

ECDC unit 156 optionally operates in a manner similar to conventional voice band modem procedures, such as defined by the V.42 and V.44 standards. Specifically, for transmission, ECDC unit 156 optionally adds data sequence numbers and in reception, ECDC unit 156 optionally requests retransmission of data not properly received. Alternatively or additionally, in transmission, ECDC unit 156 adds data for forward error correction (FEC) and in reception, ECDC unit 156 optionally regenerates data not properly received. Further alternatively, ECDC unit 156 is not included or does not reconstruct lost data, and retransmission and/or regeneration is performed in higher protocol layers.

Optionally, ECDC unit 156 performs data compression as is conventional in voice band modems. Alternatively, in order to save processing resources, and under the assumption that most transmitted data is anyhow compressed, ECDC unit 156 does not compress the transmitted data. Further alternatively, ECDC unit 156 performs data compression only when there is sufficient available processing power.

In some embodiments of the invention, modulator/demodulator 154 and ECDC unit 156 operate on one or more coordinated processors. When the frequency bands used for data transmission are relatively narrow, the processing power required for modulation and demodulation is relatively low, while the need for compression is relatively high, in order to supplement the relatively narrow frequency bands. In such cases, ECDC unit 156 optionally performs data compression. When the usable frequency band is relatively wide, compression is optionally not performed. Alternatively or additionally, ECDC unit 156 may perform data compression at different levels of intensity according to the available processing power. In some embodiments of the invention, the available processing power is evaluated, in determining whether to perform data compression, for each connection at the time at which the connection is established. Optionally, the available processing power determined for each connection is based on the parameters of that specific connection. Alternatively or additionally, the determination of whether to perform data compression is taken by server modem 104 which services a plurality of client modems 102, based on the processing power utilization of all the connections it handles.

In some embodiments of the invention, a filter is located between hybrid 150 and A/D 152 to reduce the effect of noise from the transmission bands on the reception bands. Alternaively or additionally, a filter is employed between D/A 153 and hybrid 150 for similar reasons. Properly adjusted filters, according to the currently used upstream and/or downstream bands, may allow use of higher data rates and/or may remove the need for performing echo cancellation during data transmission.

As mentioned above, in some embodiments of the invention, modems 102 and 104 are planned primarily for use with long copper lines. Such lines suffer from relatively harsh attenuation and noise levels. Optionally, the modulation method is adapted to achieve maximal throughput given these harsh conditions. In some embodiments of the invention, different frequency bands are used for upstream and downstream transmission, as is conventional with DSL methods, so that the echo from the transmission does not severely interfere with the reception of signals. Alternatively, in order to achieve higher throughput, frequencies which have relatively low attenuation, e.g., low frequencies, carry both upstream and downstream signals.

Optionally, the upstream band and/or the downstream band is divided into a plurality of sub-bands, which are handled separately, with respective carriers. The use of separate sub-bands, although requiring more processing resources, allows higher data throughput of the available bandwidth, as each sub-band may be adjusted to the conditions of the frequencies on which it is transferred.

In some embodiments of the invention, the signals on each sub-band are modulated using quadrature amplitude modulation (QAM). Alternatively or additionally, a carrierless amplitude phase (CAP) modulation is used. Further alternatively or additionally, any other modulation method with a high throughput per Hz, is used.

In an exemplary embodiment of the invention, the signals on each sub-band are modulated using a high throughput modulation method, such as a method similar to that used by the V.34 recommendation. Optionally, the modulation includes precoding, shell mapping and pre-emphasis. Optionally, the transmitted data is encoded using trellis coding. Alternatively, other coding methods are used, such as turbo coding and/or low density parity coding.

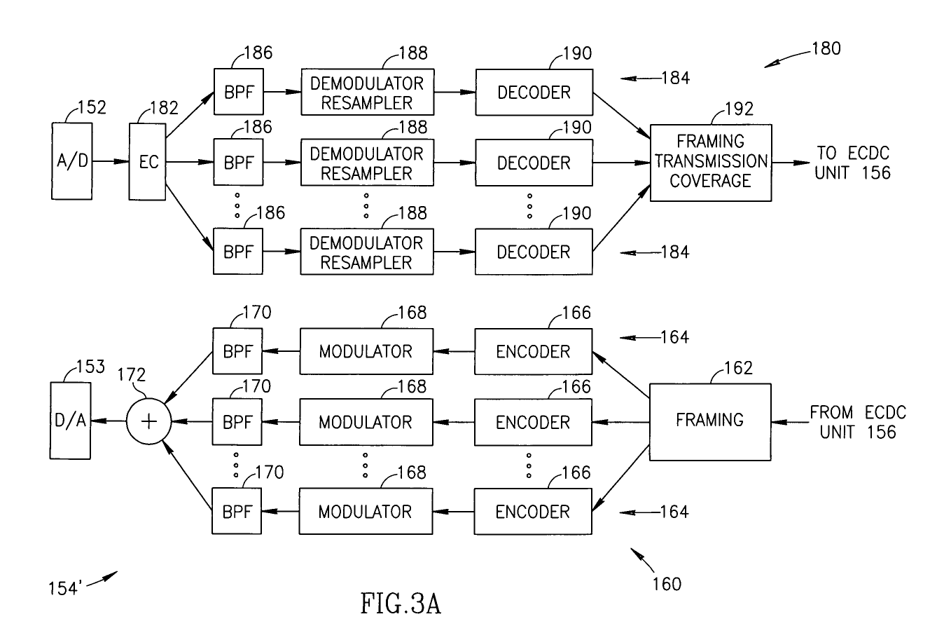

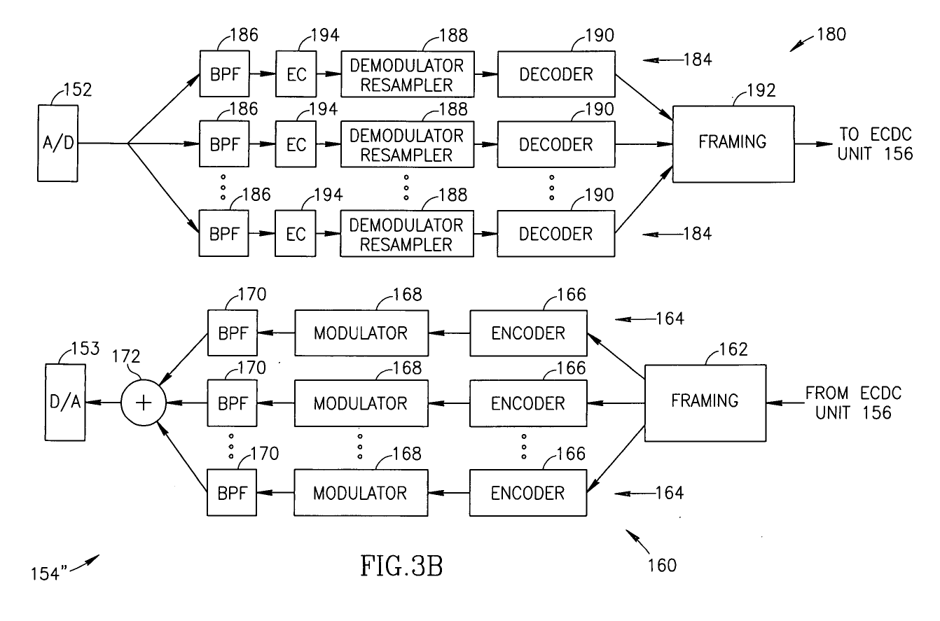

Two exemplary modulation methods for use in accordance with some embodiments of the present invention are described below with reference to FIGS. 3A and 3B. It is noted, however, that many other methods may be used, and FIGS. 3A and 3B are only exemplary. As noted above, the block diagrams of FIGS. 3A and 3B are illustrative and the tasks of all the blocks may be performed by a single processor, in separate processes or in one single process, or by a plurality of processes and/or in hardware.

FIG. 3A is a block diagram of a modulator/demodulator 154′, in accordance with an exemplary embodiment of the invention. Modulator/demodulator 154′ of FIG. 3A includes a modulation path 160 and a demodulation path 180. Data received from ECDC unit 156 is optionally passed through a framing unit 162, which distributes the data between a plurality of modulation sub-paths 164. Each sub-path 164 optionally prepares a portion of the transmitted data for transmission on a respective frequency sub-band. Each modulation sub-path 164 optionally includes an encoder 166, which performs, for example, trellis encoding, constellation shaping and precoding. A modulator 168 optionally performs pulse shaping modulation and resampling. The resultant resampled samples are optionally filtered by a respective band pass filter (BPF) 170 of the sub-channel 164, so that they do not interfere with samples of other sub-channels and are then combined by an adder 172 and passed to D/A 153, for transmission on copper wire 112.

Signals received from copper wire 112 are optionally passed after digitization by A/D 152 to an echo canceller 182, which removes echoes from all the sub-bands together. Combined echo-cancellation requires fewer processing resources, although providing a slightly less efficient result. The received signals are optionally distributed to a plurality of sub-channels 184 which each handles signals from a respective frequency sub-band. Respective band pass filters (BPF) 186 optionally filter from the received signals those signals belonging to the sub-channel. The filtered signals are optionally demodulated and resampled by a demodulator 188 and decoded by a decoder 190. The decoded signals are optionally framed together by a framing unit 192, for transmission to ECDC 156.

FIG. 3B is a block diagram of modulator/demodulator 154″, in accordance with another exemplary embodiment of the invention. Modulator/demodulator 154″ of FIG. 3B is similar to that of FIG. 3A, but instead of including a general echo cancellation unit 182, includes separate echo cancellation units 194 for each sub-channel. Using separate echo cancellation units 194 for each sub-channel allows training each unit 194 for the specific conditions of its respective sub-band. Such separate training may require, however, additional processing resources.

Alternatively to using either the echo cancellation method of FIG. 3A or of FIG. 3B, in some embodiments of the invention, the echo cancellation method used is selected according to the available processing resources of modems 102 and/or 104, for example under similar guidelines as discussed above regarding the compression method used. Alternatively or additionally, echo cancellation is performed for all the sub-channels together initially and/or periodically at a first rate, and for each sub-channel separately at a second rate.

Further alternatively, during transmission, echo cancellation is not performed on sub-bands which carry signals in only a single direction. This alternative is optionally used when the modems include effective filters. Alternatively or additionally, echo cancellation is performed only on sub-bands close to the border point between the upstream and downstream bands.

Server modem 104 is optionally implemented in a manner similar to client modem 102. Server modem 104 is optionally implemented as part of an array of modems, for example running on an MSC 8102 DSP.

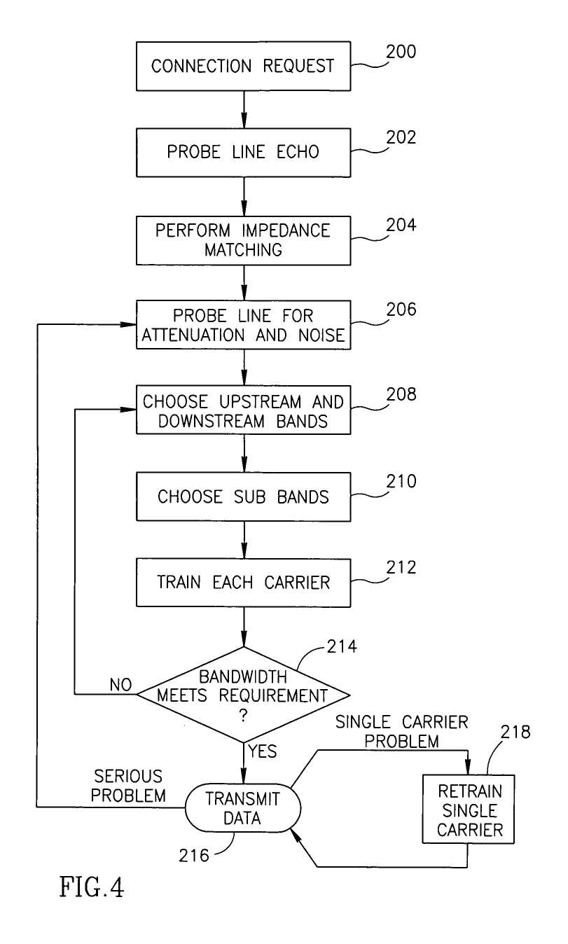

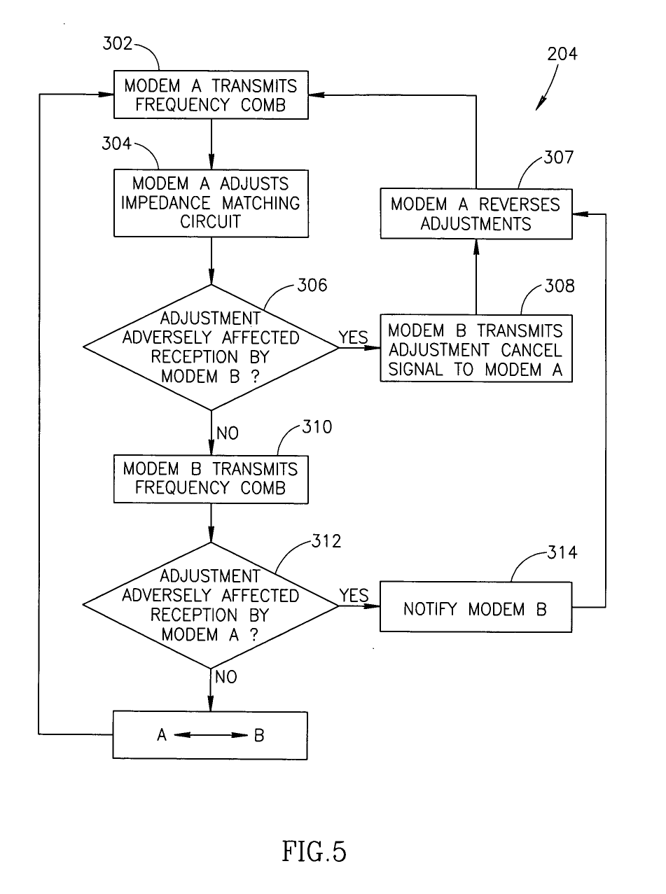

FIG. 4 is a flowchart of acts performed in managing a wide-band modem connection, in accordance with an exemplary embodiment of the invention. Optionally, when broadband service is desired, client modem 102 transmits (200) a connection request tone to CO modem 104. Thereafter, according to a predetermined protocol arrangement, modems 102 and 104 probe (202) copper wire 112, in a first probing, in which the echo properties of wire 112 are determined. Thereafter, the parameters of the impedance matching values are optionally adjusted (204) by client modem 102 and/or CO modem 104. An exemplary method for adjusting the impedance matching values is described below with reference to FIG. 5. The adjustment of the impedance matching values is optionally performed iteratively with cooperation between modems 102 and 104. When the impedance matching adjustment is completed, an additional, second, probing (206) of the line is optionally performed in order to determine the attenuation and noise characteristics of the line.

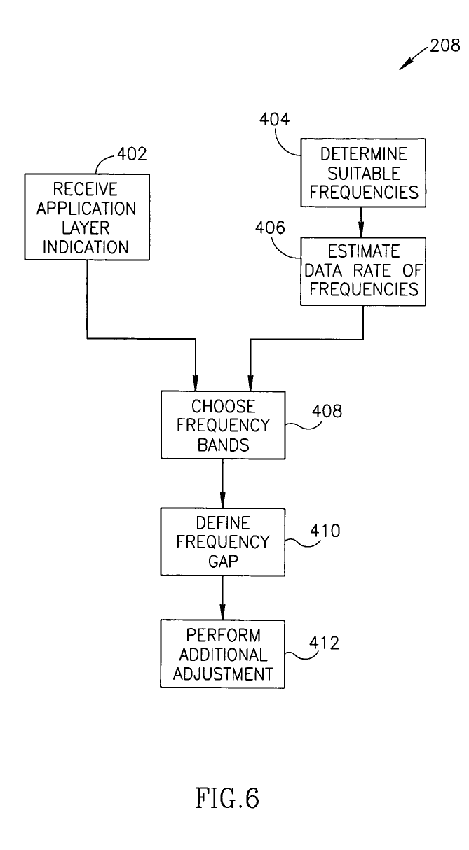

The additional probing optionally results in determination of the available bandwidth for transmission and the transmission quality of the different frequencies. According to the results of the additional probing (206), and optionally also application layer preferences (discussed in detail below), upstream and downstream frequency bands are chosen (208). An exemplary method for choosing the upstream and downstream bands is described below with reference to FIG. 6. For each of the upstream and downstream bands, one or more separate sub-bands, having separate carriers, are chosen (210). Optionally, the carriers are chosen at the middle points of the sub-bands. Each of the sub-bands is then trained (212), separately, so as to define modulation parameters of the sub-band. The selection of the modulation parameters results in a data rate of the sub-band, which corresponds to the selected modulation parameters. In some embodiments of the invention, the resultant data rates of the sub-bands are checked (214) to verify that minimal data rate requirements of the upstream and/or downstream are achieved. If (214) the minimal data rate requirements are not achieved, the modem connection optionally returns to choosing of upstream and downstream bands so as to achieve the minimal data requirements, optionally only if there is a reasonable expectation to achieve the minimal data rates.

Optionally, the minimal data rate requirements are set to a bare minimum, so as not to lengthen the connection stage (the stage in which data is not transmitted) on the modem connection. Alternatively or additionally, the choosing (208) of the upstream and downstream bands allows for margins that minimize the chances of not meeting the minimum requirements.

If (214) the minimal requirements are met, the modem connection moves to a data transmission state (216). If during the transmission state (216) a sub-band fails, the sub-band is retrained (218), while the other sub-bands continue to transmit data. If during the data transmission the entire connection fails the connection is reinitiated from probing (206) the line for attenuation and noise. Alternatively, or if the reinitiation from probing (206) is not successful, the connection is restarted beginning with a connection request tone (200) or from the probing (202) of the line echo.

It is noted that the modem connection may be an always-on connection which needs reconnection only at installation and after connection failure, or may be an on-demand connection which is connected whenever the user wishes to transfer data and is disconnected when not in use and/or when the telephone is to be used without interference from the data transmission. In some embodiments of the invention, as discussed above, the telephone may only be used when the data connection is not operable, for example since the data connection uses voice band frequencies. In these embodiments, when the telephone is to be used, the data connection is optionally disconnected. After the telephone conversation is completed, the connection may be re-established.

Referring in more detail to the first and second probings of the copper line (202), in some embodiments of the invention, the first probing is performed on a predetermined frequency band which may possibly be used by the modem connection.

In some embodiments of the invention, the probed frequency band does not include the voice frequency band (e.g., up to 4 KHz) which is reserved for plain old telephone service (POTS) in parallel to modem service. Optionally, in these embodiments, the lower limit of the probed frequency band is separated from the voice frequency band by a separation margin of about 2-4 KHz, so as to prevent disturbances of the data transmission to the voice band. Optionally, the safety margin is selected to be narrow relative to the art, for example allowing up to about a 10-20% degradation of the voice quality of the voice band due to noise from the modem connection. Leaving only a narrow safety margin allows a better utilization of the available bandwidth, especially when the twin pair line is relatively long and therefore high frequencies are not suitable for carrying data. Alternatively or additionally, the client may select at subscription, or at transmission (200) of the connection request, the extent to which the voice quality of the POTS may be affected. Further alternatively or additionally, filters are used to minimize the disturbance to the voice band from the data connection.

Alternatively or additionally, the width of the separation margin is selected so as to prevent disturbances of the voice band to the data transmission. Optionally, in accordance with this alternative, a degradation of up to about 20-30% in the quality of the modem connection on the sub-band closest to the voice band is allowed. Alternatively, the sub-band closest to the voice band is allowed to be severely degraded while the voice band is in use, under the assumption that at most times that the voice channel is used, the data connection is not used at full capacity. As described below, the connection is optionally adapted to adjust with minimal delay to varying conditions, for example due to use of the voice band of the twin pair line, such that it is worthwhile to utilize the frequency band near the voice band, even if changes in the data connection are required when the telephone service is used.

Alternatively to the probed frequency band beginning above the voice band, the entire frequency band as close as possible to the DC band is probed. In an exemplary embodiment of the invention, the probed frequency band begins at about 400-1000 kHz, depending on the quality of the filters used and/or exact sub-band division of the bandwidth. In accordance with this alternative, telephone signals are optionally transmitted in digital format over the modem connection or the telephone is used only when the data connection is inoperative. This alternative allows utilizing the voice frequency band for data, when it is not used for POTS.

In some embodiments of the invention, the probed frequency band ranges on its upper end up to an upper frequency which has a very slight chance of being useful (for example, due to very high attenuation). Alternatively, the upper end of the probed frequencies is set at a frequency which is probably usable for transmission and resources are not wasted on probing frequencies that are probably useless. Optionally, the frequency bands that are probed are set at the time of installation of modems 102 and 104, based on the type of the line (e.g., copper wire or other), the length of the line and/or a testing of the twin pair line.

In some embodiments of the invention, the same frequency ranges are probed in the first and second probings. Alternatively, the second probing is performed on a smaller range selected based on the results of the first probing. Optionally, in accordance with this alternative, during adjustment (204) of the impedance matching circuit, the frequencies to be excluded from further consideration are determined. Further alternatively or additionally, the second probing which is used to determine which frequencies are to be used is performed on a wider band than the first probing.

Referring in more detail to the echo probing, in some embodiments of the invention, the echo probing includes a relatively long chirp probing, so as to determine for each transmitted frequency its basic echo effect. Optionally, the echo probing (202) is optionally governed by a predetermined protocol which sets the times of the actions performed by each of modems 102 and 104. Optionally, each of modems 102 and 104, in turn, transmits its chirp signals and determines the echo effects, while the opposite modem remains silent. The opposite modem optionally determines the attenuation of wire 112 based on the transmitted signals while the transmitting modem determines the echo effects. Alternatively, the opposite modem does not perform any tests during the echo probing.

FIG. 5 is a flowchart of acts performed in adjusting (204) impedance matching circuits of modems 102 and 104, in accordance with an exemplary embodiment of the invention. A first modem, referred to as modem A, transmits (302) a frequency comb of sine signals at different frequencies. In parallel, modem A adjusts (304) its impedance matching circuit, by up to a predetermined change step, in a direction which minimizes echo affects on the reception of signals. Modem B optionally also listens to the transmitted signals and determines (306) whether the adjustments performed by modem A adversely affect, to a substantial extent, its reception of the signals. If (306) modem B determined that the adjustments by modem A adversely affected the reception of modem B, modem B transmits (308) an adjustment cancellation signal to modem A, modem A reverses (307) those adjustments and performs different adjustments and/or performs adjustments of a lesser extent.

If (306) modem B was not adversely affected by the adjustments of modem A, modems A and B change roles, and modem B transmits (310) a comb of sine signals. At first, modem A optionally determines whether (312) its adjustments adversely affected its reception. If (312) the reception was adversely affected, modem A optionally notifies (314) modem B, reverses (307) the adjustments, and performs different adjustments and/or performs adjustments of a lesser extent.

If (312) the reception was not adversely affected, modem A notifies modem B accordingly and modem B adjusts its impedance and modem A determines whether the adjustments adversely affect the reception by modem A. This process is optionally repeated until no additional substantially beneficial adjustments may be performed. Alternatively or additionally, the process is ended after a predetermined number of iterations were performed.

Referring in more detail to adjusting (304) the impedance matching circuit, in some embodiments of the invention, the adjustment in a single iteration includes small steps in a plurality of different frequencies. In some embodiments of the invention, the allowed change in a single iteration includes changing for substantially all the frequencies by a small step.

Optionally, the maximal step size remains constant throughout the adjustment procedure. Alternatively, the maximal step size is large at the beginning and is reduced when the procedure is closer to convergence. Further alternatively or additionally, the maximal step size is set according to the extent in which previous adjustments were cancelled. Optionally, each time an adjustment is cancelled, the step size is reduced. The step size is optionally enlarged after a predetermined adjustments were not cancelled.

Alternatively to the modems transmitting the comb signals at separate times, both modems transmit comb signals on different frequencies and the adjustments are performed in parallel. Optionally, each of the modems transmits the comb signals on half of the relevant spectrum and then the modems exchange frequencies. In some embodiments of the invention, this alternative is used only during some of the iterations, for example at the beginning when the modems are far from convergence and/or at the end when the modems are close to convergence and the steps are small.

In some embodiments of the invention, an adjustment is considered beneficial if the amplitude of the received signals compared to what was transmitted, increases. Alternatively or additionally, the amplitude of the received signals are compared to the amplitude of the received signals at a specific frequency.

Optionally, adjustments are considered having a substantial adverse effect if the signal to noise ratio (SNR) of the received signals is reduced by more than a predetermined percent (e.g., 1%) and/or by more than a predetermined decibel (e.g., 1 db).

In some embodiments of the invention, reversing adjustments includes canceling the adjustments entirely. Alternatively, the adjustments are cancelled only partially, for example based on a compromise between the extent of the adverse effect and the extent of the correction. In the next iteration, the adjustments are tested for correction.

Alternatively to all the iterations of matching adjustment being performed in a direction which reduces echo effects, in some embodiments of the invention, at least some of the iterations are performed in a direction which reduces the attenuation of received signals, without adversely affecting the echo. In these alternatives, the adjustments are optionally performed by modem A, while modem B transmits the frequency comb. Alternatively or additionally, at least some of the iterations are performed in a direction which reduces the attenuation of transmitted signals. In these iterations, the changes are optionally performed based on instructions from the opposite end modem. Optionally, different iterations are directed to different objectives. In some embodiments of the invention, the iterations are performed in pairs and/or triplets. In each group of iterations, a single iteration is performed in each direction (e.g., minimizing echo, minimizing transmission attenuation, minimizing reception attenuation).

Alternatively to each iteration being directed according to a single parameter, one or more iterations are directed to optimizing a plurality of parameters at which according to an optimization method. In this alternative fewer iterations, or even a single iteration, may be used.

Alternatively to performing adjustment of the impedance matching circuit each time a connection is initiated, the adjustment is optionally performed only if the values from the previous adjustment are old (e.g., over a week or a month). Alternatively or additionally, the connection is attempted with the old impedance matching values and only if suspiciously low data rates are achieved is the impedance matching adjustment performed.

In some embodiments of the invention, the user of client modem 102 may select if a regular long training is to be performed or if a fast training which skips the impedance matching adjustment (and/or other non-essential stages) is to be performed. For example, when the user is checking for an urgent e-mail message, a fast training may be used, while when the user desires to download DVD movies the user may request a full training which maximizes throughput.

Referring in more detail to the second probing (206), in some embodiments of the invention, the second probing is performed by each of the modems transmitting a frequency comb, while the other modem determines the attenuation of wire 112 and/or its noise level for each frequency. Optionally, the probing is performed with each of the modems transmitting a frequency comb in a predetermined order.

In some embodiments of the invention, the results of the second probing are evaluated to determine whether a sufficient wire quality was achieved. Optionally, if the wire quality is not sufficient, the impedance matching adjustment is repeated beginning from the first probing.

FIG. 6 is a flowchart of acts performed in choosing (208) the upstream and downstream bands, in accordance with an exemplary embodiment of the invention. Optionally, client modem 102 receives (402), from an application layer thereof, an indication of a desired ratio between the upstream and downstream data rates, a minimal upstream and/or downstream data rate and/or any other indication pertaining to the desired upstream and downstream data rates. Based on the second probing, each of modems 102 and 104 determines (404) which frequencies are suitable for receiving signals and estimates (406) the data rates which can be achieved from the suitable frequencies. In some embodiments of the invention, a lower frequency band is used for upstream transmission, and a higher frequency band is used for downstream transmission. Server modem 104 is generally more affected by noise from adjacent communication lines and therefore the upstream transmissions it needs to receive are optionally lower frequency bands which are less susceptible to noise.

The received application layer indications, the determined frequencies and the estimated data rates are optionally exchanged between the modems. According to the received application layer indications and the results of the estimation, the widths of the upstream band, from the lowest available frequency, and of the downstream band from the highest available frequency, are chosen (408). The choosing (408) of the bands is optionally performed by both the modems according to predetermined protocol rules. Alternatively, one of the modems chooses the bands and notifies the other modem which bands were chosen.

In some embodiments of the invention, the noise affects of adjacent upstream and downstream frequencies are estimated and accordingly a frequency gap between the upstream and downstream bands is defined (410), if necessary. Optionally, additional adjustment of the upstream and/or downstream gaps is performed (412) in view of the size of the frequency gap.

Alternatively to using the method of FIG. 6, any other method of dividing the bandwidth between the upstream and the downstream may be used. For example, a zipper allocation of the bandwidth, in which sub-bands of upstream and downstream are interleaved, may be used.

As discussed above, some of the parameters of the connection set-up may be chosen based on application layer indications. In some embodiments of the invention, the application layer indications are received from a human user or determined based on instructions from a human user. For example, the user may select one of a predetermined divisions between upstream and downstream bandwidth. For example, a dominantly upstream division may be selected for transmitting heavy files, a dominantly downstream division may be selected for Internet access and data download and an equal division may be used for other purposes. Alternatively or additionally, the application layer indications are determined by a modem control software, for example based on the modem usage history of computer 108.

The parameters determined by the application layer may include substantially any parameter of interest to the user and/or the application software, such as the division between upstream and downstream bandwidth. The application layer indications may optionally include indication of the number of sub-bands used, for example based on the desirability of changing sub-bands between upstream and downstream use.

Referring in more detail to choosing (210) the sub-bands, in some embodiments of the invention, each of the upstream and downstream bands is handled separately. For each of the bands, a start point, optionally at an end of the band, is selected. Optionally, the start points are the lowest frequencies of the bands. Alternatively or additionally, the start points are the points closest to the border between the bands.

Attributes (e.g., amplitude attenuation, phase change) of the frequencies at the start point are determined. The frequencies from the start point until a frequency at which the attributes still do not differ substantially (e.g., by 5-10%) from those at the start point, are defined as belonging to a single sub-band. A gap is then defined and a next frequency after the gap from the previous sub-band is chosen as a start point and the process is repeated until the entire frequency band is divided into sub-bands. The gap is optionally of a width between 2-10% of the width of the sub-band, according to quality of the filters used.

Alternatively to dividing the bands into sub-bands only according to their attributes, a maximal sub-band width is defined. Limiting the width of sub-bands limits the amount of unusable bandwidth when sub-bands are retrained, since as described below the other sub-bands may continue to transmit data during a retrain of one of the sub-bands. In addition, in most cases the utilization of the bandwidth of the sub-band is greater for narrower sub-bands, which generally have more uniform attribute values.

Further alternatively or additionally, a maximal number of sub-bands is defined. Setting a maximal number of sub-bands limits the amount of processing power used for demodulation as the consumption of processing power increases with the number of sub-bands. Optionally, the maximal number of sub-bands is adjusted according to the available processing power.

In some embodiments of the invention, each band is divided into at least a predetermined number of sub-bands. Optionally, each band is divided into at least two sub-bands, such that in case one of the sub-bands is retrained the other sub-band may continue to serve for transferring data. Thus, in those embodiments of the invention that use in-band transmission of control data, control data can be used generally during the retraining.

In some embodiments of the invention, the same number of sub-bands are defined for upstream and downstream transmission. Optionally, the sub-bands of the upstream and downstream are paired, for signaling purposes. Alternatively, different numbers of sub-bands may be included in the upstream and the downstream bands.

Optionally, in embodiments in which the voice band is reserved for telephone service, the upstream sub-band (or a plurality of sub-bands) closest to the voice band is set to a width which includes the frequencies affected by noise from the telephone service but no frequencies that are not seriously affected by the telephone service. Thus, when the telephone service interferes with the data transmission only the upstream closest to the voice band is affected and frequency is not wasted.

It is noted that, in accordance with the above described methods, different sub-bands in the same direction may have different widths. Furthermore, the sub-bands in the same direction may include substantially any number, and even if there are more than two adjacent sub-bands they do not need to be included in an array of sub-bands of a number divisible by four, sixteen or sixty four.

The training (212) of the sub-bands is optionally performed using methods known in the art, for example using procedures similar to those of the third and fourth phase of the V.34 recommendation.

Optionally, the transmission of data on each sub-band commences when its training is completed without waiting for the other sub-bands to complete their training.

In some embodiments of the invention, during data transmission (e.g., notification on a sub-band to be retrained) is provided in-band interleaved with the data bits. Alternatively or additionally, a separate narrow channel is assigned for control data, in one or both directions. Further alternatively or additionally, separate tones may be used on the sub-bands which carry data, in order to convey important signaling messages.

In the above description, each sub-band was suggested for use in either the upstream or the downstream and not both, in order to reduce the echo effects which may interfere in signal reception. Alternatively or additionally, when one or more sub-bands is identified as having very good conditions, e.g., low noise and/or attenuation, the sub-band may be trained to carry both upstream and downstream signals.

In some embodiments of the invention, one or more sub-bands may be used for either upstream or downstream transmission according to the current transmission needs. For example, when it is determined that a buffer of the upstream is much more loaded than the downstream buffer, or when a user indication is received indicating that more upstream data is expected, one of the downstream sub-bands is retrained for upstream transmission. In some embodiments of the invention, one or more of the sub-bands is pre-selected at the time of choosing the sub-bands for transfer between upstream and downstream transmission according to the conditions. The preselected sub-band is optionally one with suitable transmission properties for both upstream transmission. In some embodiments of the invention, the width of the gap between the sub-band and its neighboring sub-bands is selected according to its dual purpose. In some embodiments of the invention, the initial training of the sub-band is performed for both upstream and downstream, so that a short retrain may be performed in changing transmission direction. Alternatively, during the retrain the entire training required is performed.

Optionally, when the telephone is lifted for usage, a sub-band closest to the voice band is retrained for accommodating the interference from the voice band with a lower data rate. If necessary, one of the other sub-bands changes direction in order to compensate for the lost throughput of the sub-band close to the voice band. It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of establishing a modem connection, comprising:
determining properties of a line carrying the modem connection; and
selecting a plurality of frequency sub-bands to pass on the connection responsive to the determination of the properties, the selection including determining the bandwidth of at least one of the sub-bands.

2. A method according to claim 1, wherein the determined properties include an echo of the line.

3. A method according to claim 1, wherein the determined properties include an attenuation of the line.

4. A method according to claim 1, wherein selecting the plurality of frequency sub-bands comprises selecting a plurality of sub-bands in a same direction.

5. A method according to claim 4, wherein at least two adjacent sub-bands in the same direction have different bandwidths.

6. A method according to claim 1, wherein selecting the plurality of frequency sub-bands comprises selecting at least one uplink sub-band and at least one downlink sub-band.

7. A method according to claim 1, wherein at least one gap of bandwidth not used by the modem connection is left between at least two of the plurality of sub-bands.

8. A method according to claim 7, wherein the selecting includes selecting the width of the at least one gap.

9. A method of establishing a modem connection, comprising:
determining properties of a line carrying the modem connection;
selecting a plurality of frequency sub-bands to pass on the connection responsive to the determination of the properties, the plurality of sub-bands including at least two sub-bands carrying data in the same direction, which have different band widths; and
training the selected sub-bands for data transmission.

10. A method according to claim 9, wherein training the selected sub-bands is performed with separate, unrelated, timers.

11. A method of preparing a modem connection for data transmission, comprising:
determining properties of a line carrying the modem connection; and
selecting frequencies to be used for upstream transmission and frequencies to be used for downstream transmission, responsive to the determination of the properties, the frequency selection including determining for at least one frequency whether it is to be included in an upstream or downstream frequency band.

12. A method according to claim 11, wherein selecting the frequencies for upstream and downstream transmission comprises selecting additionally responsive to an application layer indication of selection preference.

13. A method according to claim 11, comprising dividing the selected upstream or downstream frequencies into a plurality of sub-bands with separate carriers.

14. A method of preparing a modem for data transmission on a communication line, comprising:
transmitting test signals on the communication line;
receiving an indication on reception properties of the test signals or on required impedance matching changes from an opposite end modem connected to the line; and
adjusting an impedance matching circuit of the modem responsive to the received indication.
